(19) United States
(12) Patent Application Publication
(10) Pub. No.: US 2025/0115189 A1
(43) Pub. Date: Apr. 10, 2025

(54) VEHICLE FRONT STRUCTURE

(71) Applicant: SUBARU CORPORATION, Tokyo (JP)

(72) Inventor: Akihiro MAEDA, Tokyo (JP)

(21) Appl. No.: 18/982,026

(22) Filed: Dec. 16, 2024

Related U.S. Application Data
(63) Continuation of application No. PCT/JP2023/018758, filed on May 19, 2023.

(51) Int. Cl. B60R 5/02; B60R 11/00; B62D 25/08

(52) U.S. Cl. CPC B60R 5/02; B62D 25/087; B60R 2011/0082; B60R 2011/0085

(57) ABSTRACT

A vehicle front structure includes: side frames in a left and right pair; strut towers in a left and right pair that are each located respectively on outer sides of the side frames continuously in a vehicle width direction; a hood configured to open and close a housing space in which at least a drive motor is disposed; a moving mechanism attached to at least the side frames; and a frunk attached to the moving mechanism and positioned above the drive motor. The frunk is movable at least in a front-rear direction according to an operation of the moving mechanism and is movable forward in a state where the hood is opened. The frunk is movable upward in the state where the hood is opened, and an upper end of the moving mechanism is attached to a lower end of the frunk.

### CROSS REFERENCE TO RELATED APPLICATIONS

This application is continuation of International Application No. PCT/JP2023/018758, filed on May 19, 2023, the entire contents of which are hereby incorporated by reference.

### BACKGROUND

The disclosure relates to a technical field of a vehicle front structure in which a frunk can be accommodated in a housing space positioned on a front side of a vehicle cabin.

Examples of vehicles such as automobiles include electric vehicles (electric automobiles). In the electric vehicles, a drive motor instead of an engine is accommodated as a driving source in a housing space positioned on a front side of a vehicle cabin, and the electric vehicles are driven by power output from the drive motor. Since the drive motor is desirably positioned close to a wheel (front wheel), the drive motor is accommodated on a back and lower side of the housing space.

Some such electric vehicles include a frunk capable of storing a stored item in a housing space where a drive motor is accommodated (see, for example, Japanese Patent No. 5992974 and Japanese Unexamined Patent Application Publication (JP-A) No. 2021-146741).

### SUMMARY

An aspect of the disclosure provides a vehicle front structure. The vehicle front structure includes: side frames in a left and right pair; strut towers in a left and right pair that are each located respectively on outer sides of the side frames continuously in a vehicle width direction; a hood configured to open and close a housing space in which at least a drive motor is disposed; a moving mechanism attached to at least the side frames; and a frunk attached to the moving mechanism and positioned above the drive motor. The frunk is movable at least in a front-rear direction according to an operation of the moving mechanism and is movable forward in a state where the hood is opened. The frunk is movable upward in the state where the hood is opened, and an upper end of the moving mechanism is attached to a lower end of the frunk.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1, together with FIGS. 2 to 8, illustrates an embodiment of a vehicle front structure of the disclosure, and is a diagram illustrating a schematic configuration of a vehicle.

FIG. 2 is a perspective view illustrating a part of the vehicle front structure.

FIG. 3 is a plan view illustrating a part of the vehicle front structure.

FIG. 4 is a front view conceptually illustrating a part of the vehicle front structure.

FIG. 5 is a side view illustrating a part of the vehicle front structure.

FIG. 6 is a side view illustrating a part of the vehicle front structure in a state where a frunk is moved to a working position.

FIG. 7 is a side view illustrating a part of the vehicle front structure in an example in which another moving mechanism is used.

FIG. 8 is a side view illustrating a part of the vehicle front structure in a state where the frunk is moved to the working position in an example in which another moving mechanism is used.

### DETAILED DESCRIPTION

In the vehicle in which the frunk is accommodated in the housing space positioned on a front side of the vehicle cabin as described above, when the frunk is accommodated on a leading end side of the vehicle in consideration of convenience of loading and unloading the stored item, and if the drive motor and an auxiliary device, which are high-voltage components, are subjected to impact from the frunk in the event of a collision (frontal collision) of the vehicle, this may cause secondary damage such as an electric shock, and may impair the safety of a passenger and a rescuer.

On the other hand, in a case where the frunk is accommodated on an upper side of the drive motor in consideration of safety, the frunk is positioned on a back side of the housing space, and thus the position of the frunk is away from the user, which may impair the convenience of loading and unloading the stored item to and from the frunk.

It is desirable to improve convenience of loading and unloading a stored item to and from a frunk while ensuring safety in the vehicle.

An embodiment of a vehicle front structure according to the disclosure will be described below with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### <Schematic Configuration of Vehicle>

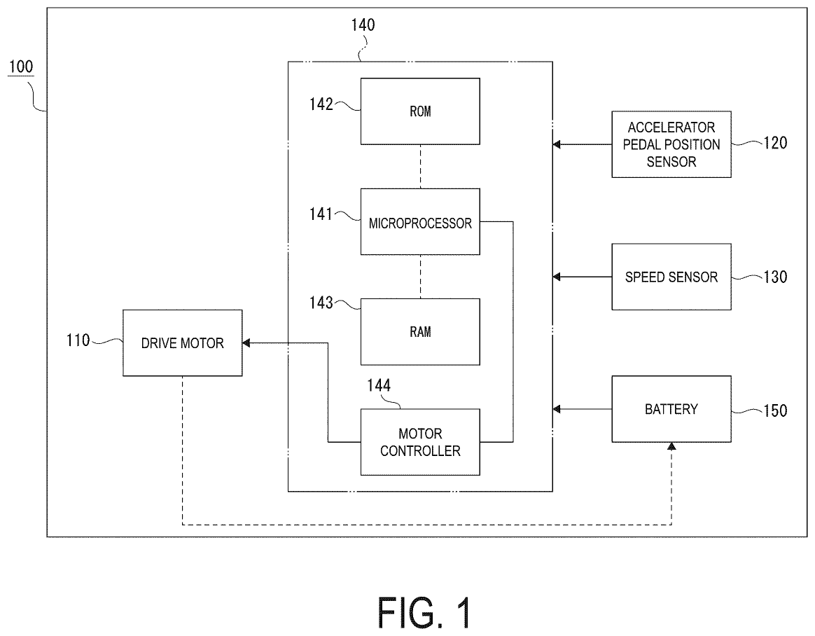

First, a schematic configuration of a vehicle will be described (see FIG. 1).

A vehicle 100 is an electric vehicle that travels only by electric power, and includes a drive motor 110, an accelerator pedal position sensor 120, a speed sensor 130, and a controller 140.

The drive motor 110 is accommodated in a space on a front side of a vehicle cabin and is used as a power source of the vehicle 100.

The accelerator pedal position sensor 120 detects an accelerator pedal position corresponding to a driving force of the vehicle 100 requested by a driver who drives the vehicle, that is, a depressed amount of an accelerator pedal by the driver. The accelerator pedal position detected by the accelerator pedal position sensor 120 is output as a detected signal to the controller 140.

The speed sensor 130 detects a speed of the vehicle 100. The speed of the vehicle 100 detected by the speed sensor 130 is output as a detected signal to the controller 140.

In one embodiment, the controller 140 may serve to integrally control an operation of each member in the vehicle 100 and perform various calculation processes. The controller 140 includes a microprocessor 141 performing calculation, a read only memory (ROM) 142 storing a program or the like for causing the microprocessor 141 to execute each process, a random access memory (RAM) 143 storing various data such as calculation results, an interface for inputting or outputting data, and the like.

The controller 140 includes a motor controller 144 controlling the drive motor 110. In one embodiment, the motor controller 144 may serve to control, for example, a driving operation of wheels of the vehicle 100 by the drive motor 110, a regenerative operation in the drive motor 110, and the like.

A battery 150 is accommodated in a trunk room or the like of the vehicle 100. The battery 150 includes a battery module storing electric power used in the vehicle 100, for example, electric power used in the controller 140, each member operated by electric power in the vehicle 100, and various types of lighting provided in the vehicle 100, and the like, in addition to electric power used in the drive motor 110. As a battery of the battery module, for example, a secondary battery such as a nickel hydrogen battery or a lithium ion battery is used. The battery 150 stores, for example, regenerative electric power supplied from the drive motor 110 in addition to electric power (charging electric power) obtained by charging from outside the vehicle 100.

### <Vehicle Front Structure and Other Members>

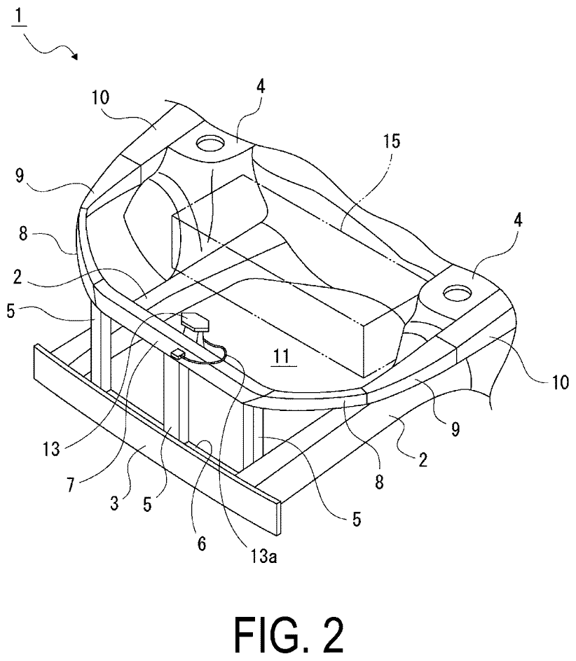

Next, the vehicle front structure and the like will be described (see FIGS. 2 to 6).

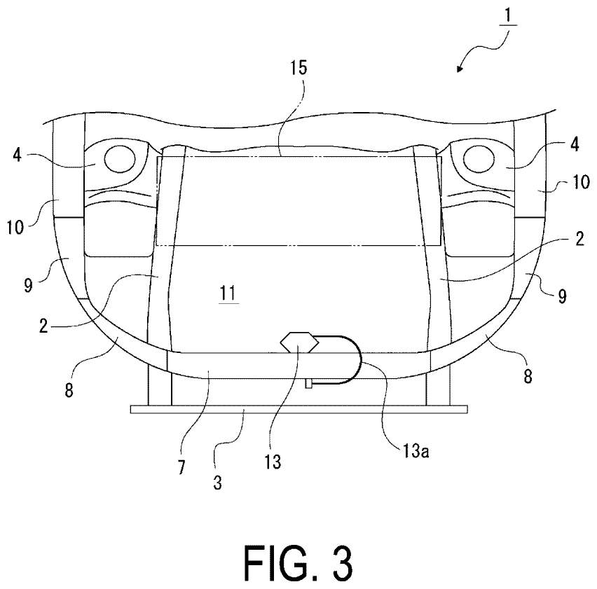

A vehicle front structure 1 includes a side frame 2, a bumper beam 3, a strut tower 4, and the like (see FIGS. 2 and 3).

A pair of the side frames 2 are provided so as to be spaced apart from each other in the left-right direction and have a shape extending in the front-rear direction. The bumper beam 3 is fastened to a front end of the side frame 2 and has a shape extending in the left-right direction. The strut tower 4 is fastened to an outer side of a rear end of the side frame 2, and has a shape protruding upward from the side frame 2. The strut tower 4 is a portion having high strength and in one embodiment, may serve to protect the vehicle cabin together with the side frame 2 in the event of a collision.

Support members 5 extending up and down are provided on a rear side of the bumper beam 3 so as to be spaced apart from each other in the left-right direction. A lower beam 6 extending in the left-right direction is fastened to lower ends of the support members 5, and an upper support 7 extending in the left-right direction is fastened to upper ends of the support members 5. Both left and right ends of the lower beam 6 may be fastened to portions on the front side of the side frames 2, respectively, or may be fastened to the portions on the front side of the side frames 2, respectively, via other members.

Upper sides 8 are fastened to both left and right ends of the upper support 7, respectively, and the upper sides 8 are inclined so as to be displaced rearward toward the outer side in the left-right direction. An upper frame 9 extending in the front-rear direction is fastened to a rear end of the upper side 8. A coupling frame 10 extending in the front-rear direction is fastened to a rear end of the upper frame 9, and an upper end of the strut tower 4 is fastened to an inner side of the coupling frame 10.

The vehicle front structure 1 includes a housing space 11 surrounded by members such as the side frame 2. The housing space 11 is a space on a lower side of a hood (bonnet) 12, and the drive motor 110 is accommodated in the housing space 11 at a position on a lower side of the side frame 2. The drive motor 110 is accommodated at a position closer to a rear side in the housing space 11.

A radiator (not illustrated) is disposed at a front end of the housing space 11. The radiator may serve as a heat exchanger. The radiator is disposed between the lower beam 6 and the upper support 7 and held by the support members 5.

A hood lock 13 is attached to the upper support 7. The hood lock 13 may serve to lock the hood 12 in a closed state by being engaged with a locking engagement member (not illustrated) provided at the hood 12.

The hood lock 13 has a double lock mechanism and is coupled by a wire 13a to a release lever (not illustrated) provided in the vehicle cabin. Thus, when the release lever is operated, the hood lock 13 is operated via the wire 13a, and a first locked state with respect to the hood 12 by the hood lock 13 is released. In a state where the first locked state is released, by inserting a finger into a gap existing on a lower side of the hood 12 and operating the hood lock 13, a second locked state with respect to the hood 12 by the hood lock 13 is released, and the hood 12 can be lifted and opened.

A frunk 15 attached to a moving mechanism 14 can be accommodated in the housing space 11. For example, the frunk 15 may include only a storage case opened upward, or may include, in addition to the storage case, a lid for opening and closing an opening of the storage case.

The moving mechanism 14 is attached across the pair of side frames 2 and the pair of strut towers 4. Thus, the frunk 15 can be accommodated on an upper side of the drive motor 110 on the back side of the housing space 11.

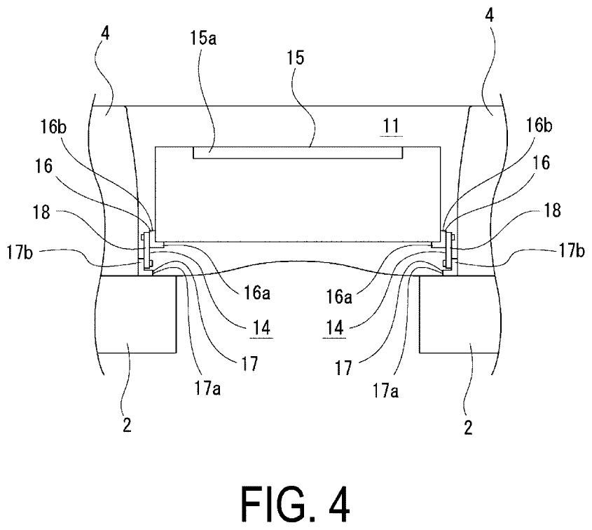

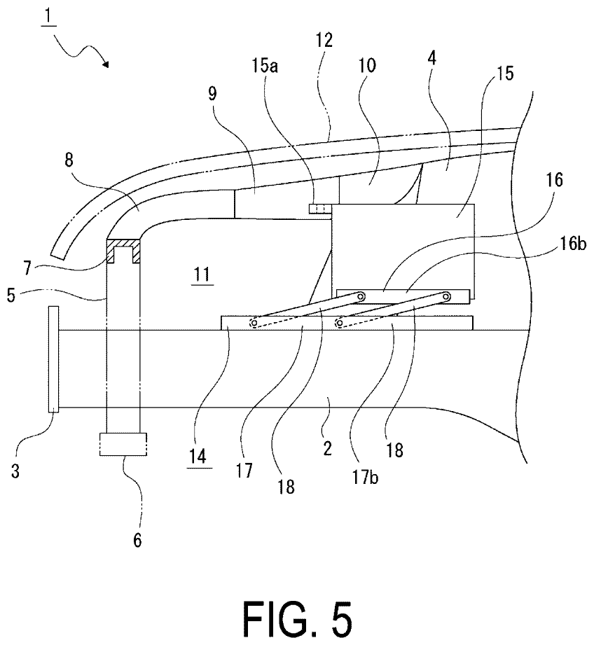

The moving mechanism 14 is provided as a link mechanism, for example, and includes a pair of left and right frunk attaching members 16, a pair of left and right attached members 17, and arms 18 (see FIGS. 4 and 5).

The frunk attaching member 16 has a shape extending in the front-rear direction, and includes a receiving surface 16a facing the up-down direction and a pressing surface 16a protruding upward from an outer end of the receiving surface 16b in the left-right direction. In the frunk attaching member 16, both left and right ends of the bottom surface of the frunk 15 are attached to the receiving surfaces 16a, and lower ends of both left and right sides of the frunk 15 are attached to the pressing surfaces 16b.

The attached member 17 has a shape extending in the front-rear direction and includes a first coupler 17a facing the up-down direction and a second coupler 17b protruding upward from an outer end of the first coupler 17a in the left-right direction. In the attached member 17, the first coupler 17a is coupled to an upper surface of the side frame 2, and the second coupler 17b is coupled to a lower end of the strut tower 4.

Two arms 18 are coupled to the frunk attaching member 16 and the attached member 17 in the front-rear direction. Thus, the moving mechanism 14 is provided as a parallel link by one frunk attaching member 16, one attached member 17, and two arms 18, and includes a pair of the parallel links positioned on the left and right, respectively. An upper end of the arm 18 is rotatably coupled to the frunk attaching member 16, and a lower end of the arm 18 is rotatably coupled to the attached member 17.

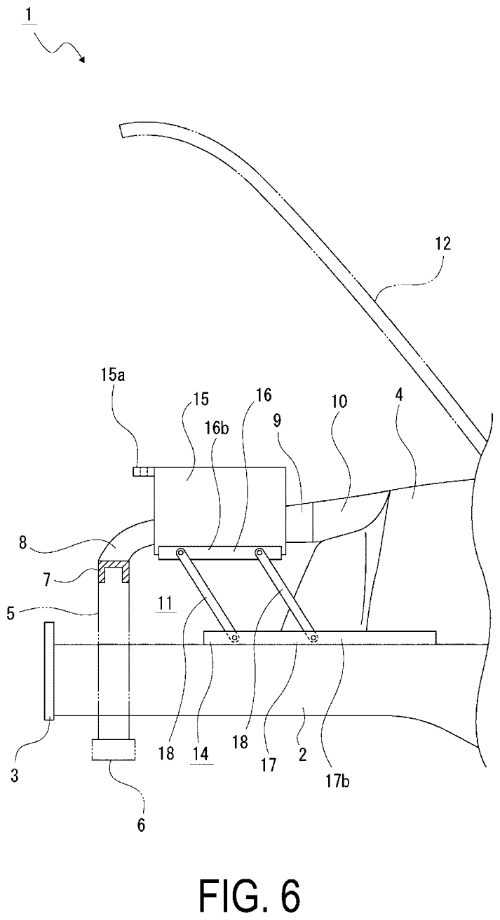

The frunk 15 includes a handle 15a at a front end and is movable in the front-rear direction and the up-down direction in a horizontal state by an operation of the moving mechanism 14. The frunk 15 is movable between a rearmost housing position (see FIG. 5) and a foremost working position (see FIG. 6) by the operation of the moving mechanism 14. The working position is a position on an upper side of the housing position, and the frunk attaching member 16 exists on an upper side of the attached member 17 at any position.

The entirety of the frunk 15 is positioned on a front side of the strut tower 4 in a state where the frunk 15 is moved to the working position which is a front end in a moving range.

The moving mechanism 14 is provided with a rotation regulator (not illustrated), and when the arm 18 is rotated with respect to the frunk attaching member 16 and the attached member 17, excessive rotation of the arm 18 is regulated by the rotation regulator, and the frunk attaching member 16 is always positioned on an upper side of the attached member 17 in a rotation range. Thus, by the rotation regulator regulating the rotation of the arm 18, the frunk 15 is held at the working position or the housing position.

In the vehicle 100, an operator (passenger) grips the handle 15a of the frunk 15 located at the housing position and pulls the handle 15a forward in a state where the hood 12 is opened, and thus the moving mechanism 14 is operated and the frunk 15 is moved to the working position obliquely forward and upward in the horizontal state. Since the frunk 15 is positioned close to the upper half of the body of the operator at the working position, the operator can easily load and unload the stored item in and from the frunk 15 without bending down the waist.

On the other hand, by pushing the frunk 15 at the working position rearward in a state where the hood 12 is opened, the moving mechanism 14 is operated, so that the frunk 15 is moved to the housing position obliquely rearward and downward in the horizontal state. By closing the hood 12 in a state where the frunk 15 is moved to the housing position, the frunk 15 is accommodated in the housing space 11.

Although the example is described above in which the working position is a position on the upper side of and the front side of the housing position, in the vehicle front structure 1, the working position may be a position at least on the front side of the housing position, and for example, the working position and the housing position may be at the same height.

As described above, the link mechanism is used as the moving mechanism 14, and the moving mechanism 14 is provided with the frunk attaching member 16 attached to the frunk 15, the attached member 17 attached to at least the side frame 2, and the arms 18 rotatable with respect to the frunk attaching member 16 and the attached member 17.

Thus, since the frunk 15 is moved in the up-down direction and the front-rear direction by rotating the arms 18 with respect to the frunk attaching member 16 and the attached member 17, the frunk 15 can be moved by a simple structure, the strength of the moving mechanism 14 is high, and a stable storage state of the stored item with respect to the frunk 15 can be ensured.

Since the attached members 17 are attached across the pair of side frames 2 and the pair of strut towers 4, a part of the moving mechanism 14 is attached to the pair of strut towers 4, and thus an effect is similar to a strut tower bar attached between the strut towers 4, distortion of the vehicle body is suppressed by the frunk 15 and the moving mechanism 14, and the strength of the vehicle body and the steering safety can be improved.

Further, since the attached members 17 are attached across the pair of side frames 2 and the pair of strut towers 4, the attached member 17 is attached to both the side frame 2 and the strut tower 4, and thus the attachment strength of the moving mechanism 14 is increased and a stable storage state of the stored item stored in the frunk 15 attached to the moving mechanism 14 can be ensured.

### <Another Example of Moving Mechanism>

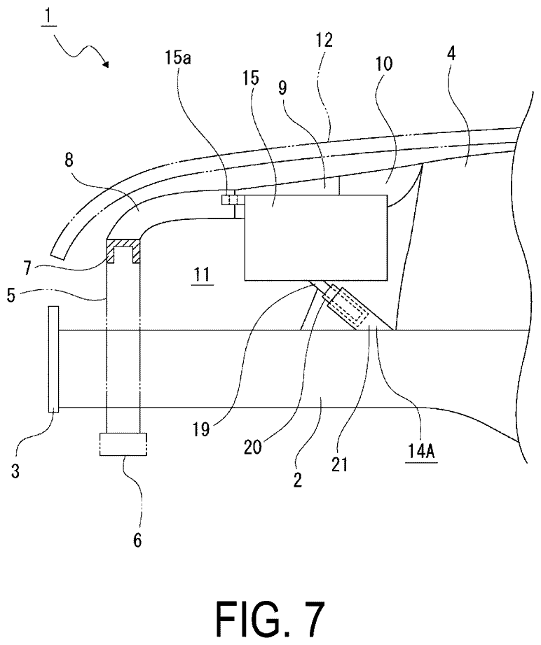

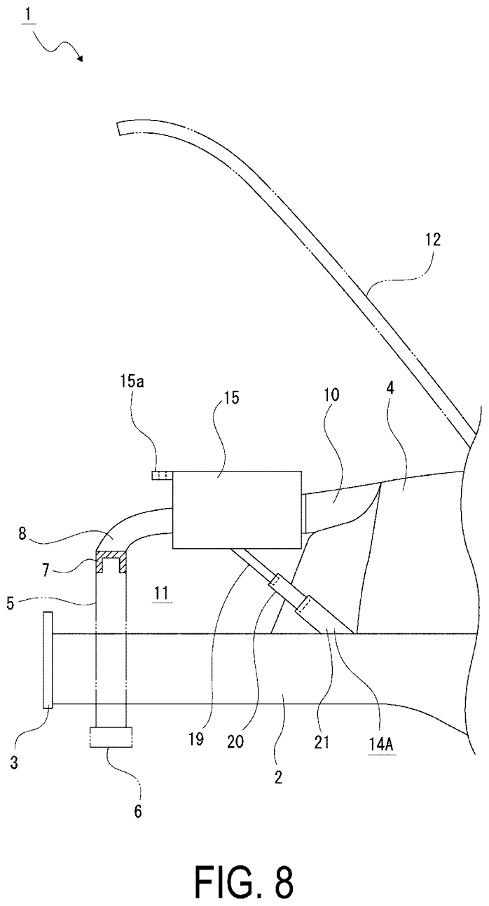

In the vehicle front structure 1, a moving mechanism 14A described below may be used instead of the moving mechanism 14 described above (see FIGS. 7 and 8).

The moving mechanism 14A is extendable, and is provided with a pair of left and right structures each including an attaching shaft 19, an intermediate cylinder 20, and an attached cylinder 21. The attaching shaft 19, the intermediate cylinder 20, and the attached cylinder 21 are inclined with respect to the horizontal direction so that front ends thereof are positioned above rear ends thereof.

The front end of the attaching shaft 19 is attached to, for example, a side surface or a bottom surface of the frunk 15.

The intermediate cylinder 20 has a cylindrical shape that is open on one side in the longitudinal direction. An outer diameter of the intermediate cylinder 20 is larger than an outer diameter of the attaching shaft 19, so that the attaching shaft 19 can be inserted into the intermediate cylinder 20. Thus, the attaching shaft 19 is movable in an axial direction with respect to the intermediate cylinder 20.

The rear end of the attached cylinder 21 is attached to, for example, the side frame 2. However, the attached cylinder 21 may be attached across the side frame 2 and the strut tower 4.

The attached cylinders 21 are attached to the pair of side frames 2 and the pair of strut towers 4, and thus a part of the moving mechanism 14A is attached to the pair of strut towers 4, so that an effect is similar to the strut tower bar attached between the strut towers 4, distortion of the vehicle body is suppressed by the frunk 15 and the moving mechanism 14A, and the strength of the vehicle body can be improved.

Further, since the attached cylinders 21 are attached across the pair of side frames 2 and the pair of strut towers 4, the attached cylinder 21 is attached to both the side frame 2 and the strut tower 4, and thus the attachment strength of the moving mechanism 14A is increased and a stable storage state of the stored item stored in the frunk 15 attached to the moving mechanism 14A can be ensured.

The example is described above in which the attaching shaft 19 is attached to the side surface or the bottom surface of the frunk 15 and the attached cylinder 21 is attached to the side frame 2. However, for example, the moving mechanism 14A may also be provided with the frunk attaching member 16 and the attached member 17 similarly to the moving mechanism 14, and the front end of the attaching shaft 19 may be attached to the frunk attaching member 16 and the rear end of the attached cylinder 21 may be attached to the attached member 17.

The attached cylinder 21 has a cylindrical shape that is open on one side in the longitudinal direction. The outer diameter of the attached cylinder 21 is larger than the outer diameter of the intermediate cylinder 20, and the intermediate cylinder 20 can be inserted into the attached cylinder 21. Thus, the intermediate cylinder 20 is movable in the axial direction with respect to the attached cylinder 21.

Since the attaching shaft 19 is movable in the axial direction with respect to the intermediate cylinder 20 and the intermediate cylinder 20 is movable in the axial direction with respect to the attached cylinder 21 as described above, the entire length of the moving mechanism 14A is changed and extended in accordance with a position of the attaching shaft 19 with respect to the intermediate cylinder 20 and a position of the intermediate cylinder 20 with respect to the attached cylinder 21.

Although the example is described above in which the moving mechanism 14A includes three members of the attaching shaft 19, the intermediate cylinder 20, and the attached cylinder 21, the moving mechanism 14A may be extendable by two members or four or more members. The moving mechanism 14A may include, for example, two members in which the attaching shaft 19 is movable with respect to the attached cylinder 21 without including the intermediate cylinder 20, or may include four or more members in which the intermediate cylinders 20 are provided between the attaching shaft 19 and the attached cylinder 21 and each intermediate cylinder 20 is movable with respect to the other intermediate cylinders 20.

The frunk 15 is movable between the housing position (see FIG. 7) positioned at the rearmost side and the working position (see FIG. 8) positioned at the foremost side by an extending operation of the moving mechanism 14A. The working position is a position on an upper side of the housing position.

In the vehicle 100, the operator (passenger) grips the handle 15a of the frunk 15 located at the housing position and pulls the handle 15a forward in a state where the hood 12 is opened, and thus the moving mechanism 14A is extended and the frunk 15 is moved to the working position obliquely forward and upward in the horizontal state. Since the frunk 15 is positioned close to the upper half of the body of the operator at the working position, the operator can easily load and unload the stored item in and from the frunk 15 without bending down the waist.

On the other hand, by pushing the frunk 15 at the working position rearward in a state where the hood 12 is opened, the moving mechanism 14A is shortened, so that the frunk 15 is moved to the housing position obliquely rearward and downward in the horizontal state. By closing the hood 12 in a state where the frunk 15 is moved to the housing position, the frunk 15 is accommodated in the housing space 11.

Although the example is described above in which the moving mechanism 14A is disposed in a state of being inclined with respect to the horizontal direction, the moving mechanism 14A may be disposed in a state of extending in the horizontal direction. In this case, the working position and the housing position are at the same height, and the frunk 15 is pulled out forward from the housing position and moved to the working position.

### CONCLUSION

As described above, in the vehicle front structure 1, the moving mechanism 14 or 14A attached to at least the pair of side frames 2 and the frunk 15 attached to the moving mechanism 14 or 14A and positioned above the drive motor 110 are provided. The frunk 15 is movable at least in the front-rear direction by the operation of the moving mechanism 14 or 14A and is movable forward in a state where the hood 12 is opened.

Thus, since the frunk 15 positioned above the drive motor 110 is movable forward in a state where the hood 12 is opened, the drive motor 110 is not subjected to impact from the frunk 15 in the event of a collision of the vehicle 100, and the stored item can be loaded and unloaded by moving the frunk 15 forward. This ensures safety in the vehicle 100 and improves convenience of loading and unloading the stored item in and from the frunk 15.

The frunk 15 is movable upward in a state where the hood 12 is opened.

Thus, since the frunk 15 is movable obliquely forward and upward in a state where the hood 12 is opened, the stored item can be easily loaded in and unloaded from the frunk 15 without bending down the waist, which can improve usability.

Further, the frunk 15 is positioned on the front side of the strut tower 4 in a state where the frunk 15 is moved to the working position which is the front end in the moving range.

Thus, since the entirety of the frunk 15 is positioned on the front side of the strut tower 4 when the frunk 15 is moved in a state where the hood 12 is opened, the frunk 15 is positioned sufficiently close to the operator, and the stored item can be easily loaded in and unloaded from the frunk 15 in a comfortable posture.

1. A vehicle front structure comprising:
side frames in a left and right pair;
strut towers in a left and right pair, the strut towers being located respectively on outer sides of the side frames continuously in a vehicle width direction;
a hood configured to open and close a housing space where at least a drive motor is disposed;
a moving mechanism attached to at least the side frames; and
a frunk attached to the moving mechanism and positioned above the drive motor, wherein
the frunk is movable at least in a front-rear direction in response to an operation of the moving mechanism and is movable forward in a state where the hood is opened,
the frunk is movable upward in the state where the hood is opened, and
an upper end of the moving mechanism is attached to a lower end of the frunk.

2. The vehicle front structure according to claim 1, wherein
the frunk is movable upward in the state where the hood is opened.

3. The vehicle front structure according to claim 2, wherein
a link mechanism is used as the moving mechanism, and
the moving mechanism is provided with a frunk attaching member to which the frunk is attached, an attached member attached to at least the side frames, and arms rotatable with respect to the frunk attaching member and the attached member.

4. The vehicle front structure according to claim 3, wherein
the attached member is attached across the side frames and the strut towers.

5. The vehicle front structure according to claim 1, wherein
the frunk is positioned on a front side of the strut towers in a state where the frunk is moved to a front end in a moving range.

6. The vehicle front structure according to claim 2, wherein
the frunk is positioned on a front side of the strut towers in a state where the frunk is moved to a front end in a moving range.

7. The vehicle front structure according to claim 3, wherein
the frunk is positioned on a front side of the strut towers in a state where the frunk is moved to a front end in a moving range.

8. The vehicle front structure according to claim 4, wherein
the frunk is positioned on a front side of the strut towers in a state where the frunk is moved to a front end in a moving range.
